(19) United States
(12) Patent Application Publication
(10) Pub. No.: US 2013/0035248 A1
(43) Pub. Date: Feb. 7, 2013

(54) Microsporidia Detection System and Method

(71) Applicant: Crystal R. Icenhour, Charlottesville, VA (US)

(72) Inventor: Crystal R. Icenhour, Charlottesville, VA (US)

(73) Assignee: PHTHISIS DIAGNOSTICS, Charlottesville, VA (US)

(21) Appl. No.: 13/476,355

(22) Filed: May 21, 2012

Related U.S. Application Data
(60) Provisional application No. 61/488,498, filed on May 20, 2011.

(51) Int. Cl. C40B 30/04; C40B 40/06

(52) U.S. Cl. 506/9; 506/16

(57) ABSTRACT

In various aspects, a multiplex primer set, a kit for performing an assay to detect microsporidia, and a method of identifying a microsporidia in a sample is provided. The multiplex PCR primer set including SEQ ID NOS 1-4. The kit includes a multiplex PCR primer set having SEQ ID NOS 1-4 and a set of probes having SEQ ID NOS 5-8. In the method a sample is obtained and a multiplex PCR assay is performed on the sample. A multiplex PCR primer set including SEQ ID NOS 1-4 is included in the multiplex PCR assay. The sample is determined to have the microsporidia in response to the multiplex PCR assay amplifying a target sequence associated with microsporidia.

### CROSS REFERENCE TO PRIOR APPLICATIONS

This application claims the benefit from U.S. Provisional Application No. 61/488,498 filed on May 20, 2011, which is hereby incorporated by reference for all purposes as if fully set forth herein.

### FIELD OF THE INVENTION

The present invention generally relates to a detection system and method. More particularly, the present invention pertains to a microsporidia detection system and a method of use thereof.

### BACKGROUND OF THE INVENTION

Current microscopic-based tests for microsporidia are time-consuming, difficult to perform, not cost-effective, and not sensitive or accurate due to the small size of microsporidial spores. Clinical specimens are conventionally examined by direct visualization under a light microscope using a modified trichrome stain. These examinations are labor intensive, requiring 90 minutes to correctly prepare the slide; additionally the slide must be analyzed by an experienced microscopist using positive control material for comparison. Artifact material in the slide preparation can be confused with microsporidial spores and lead to a false negative or false positive diagnosis.

Microbial pathogens of particular interest regarding human infections are the microsporidia species Enterocytozoon bieneusi (E. bieneusi) and Encephalitozoon intestinalis (E. intestinalis). Additional species are also of interest, including Anncaliia (formerly Brachiola) algerae, A. connori, A. vesicularum, Encephalitozoon cuniculi, E. hellem, E. intestinalis, Enterocytozoon bieneusi Microsporidium ceylonensis, M. africanum, Nosema ocularum, Pleistophora sp., Trachipleistophora hominis, T. anthropophthera, Vittaforma corneae, and Tubulinosema acridophagus. These are two common species primarily responsible for enteric microsporidiosis, presenting clinically in the form of chronic diarrhea, cholangiopathy and wasting; symptoms of the disease are indistinguishable from cryptosporidiosis (Weiss, 1995). Microsporidial infection has been widely underreported due to a lack of adequate clinical diagnostic testing (Garcia, 2002). It has been described as endemic to immunocompromised patients and is an emerging opportunistic pathogen in immunocompetent populations (Reynolds, 2000). Microsporidial disease is transmitted through contaminated food and water and has been implicated in nosocomial and zoonotic infections (Xiao, 2004).

Although symptoms of advanced disease for E. bieneusi are different from E. intestinalis, initially, they exhibit similar symptoms of severe and persistent diarrhea. Differentiation of enteric microsporidia) species is important due to unique treatment approaches. The Centers for Disease Control Medical Letter lists albendazole as the preferred treatment for E. intestinalis, while fumagillin is the drug of choice for E. bieneusi (Molina, 2002). Fumagillin is an antibiotic derived from Aspergillus fumigatus, is limited in availability, and is fairly toxic causing severe thrombocytopenia and neutropenia in ⅓ of patients treated (Molina, 2002). Albendazole is an antihelmitic, which can affect liver function, and can decrease immune function (C.D.I., 2009).

Due to the specific nature and potential severity of treatment, it is important for clinical laboratories to have diagnostic tools that differentiate between E. bieneusi and E. intestinalis. Accordingly, it is desirable to provide a microsporidia detection system and method that is capable of overcoming the disadvantages with currently utilized diagnostic methods described herein at least to some extent.

### SUMMARY OF THE INVENTION

The foregoing needs are met, to a great extent, by the present invention, wherein in some respects a microsporidia detection system and method is provided.

An embodiment of the present invention pertains to a multiplex PCR primer set including SEQ ID NO:1, SEQ ID NO:2, SEQ ID NO:3, and SEQ ID NO:4.

Another embodiment of the present invention relates to a kit for performing an assay to detect microsporidia. The kit includes a multiplex PCR primer set having SEQ ID NO:1, SEQ ID NO:2, SEQ ID NO:3, and SEQ ID NO:4 and a set of probes having SEQ ID NO:5, SEQ ID NO:6, SEQ ID NO:7, and SEQ ID NO:8.

The kit may include a first dye being attached to the SEQ ID NO:6, wherein the first dye fluoresces at a wavelength of 605-620 nanometers (nm). The kit may include a first dye being attached to the SEQ ID NO:6, wherein the first dye fluoresces at a wavelength of 613 nanometers (nm). The kit may include a second dye being attached to the SEQ ID NO:8, wherein the second dye fluoresces at a wavelength of 700-710 nm. The kit may include a second dye being attached to the SEQ ID NO:8, wherein the second dye fluoresces at a wavelength of 704 nm. The kit may include a third dye being attached to the SEQ ID NO:11, wherein the third dye fluoresces at a wavelength of 660-670 nm. The kit may include a third dye being attached to the SEQ ID NO:11, wherein the third dye fluoresces at a wavelength of 665 nm.

Yet another embodiment of the present invention pertains to a method of identifying a microsporidia in a sample. In this method a sample is obtained and a multiplex PCR assay is performed on the sample. A multiplex PCR primer set including SEQ ID NO:1, SEQ ID NO:2, SEQ ID NO:3, and SEQ ID NO:4 is included in the multiplex PCR assay. The sample is determined to have the microsporidia in response to the multiplex PCR assay amplifying a target sequence associated with microsporidia.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a flow diagram for a method of designing polymerase chain reaction (PCR) assays according to an embodiment of the invention.

FIG. 2 is an image of gel electrophoresis showing separation of the deoxyribonucleic acid (DNA) to test for the presence of polymerase chain reaction (PCR) amplified internal control DNA and microsporidia DNA in accordance with an embodiment of FIG. 1.

FIG. 3 is a graph showing the PCR efficiency of amplifying the target sequence of E. intestinalis in accordance with an embodiment of FIG. 1.

FIG. 4 is a graph showing the PCR efficiency of amplifying the target sequence of E. bieneusi in accordance with an embodiment of FIG. 1.

FIG. 5 is an image of a gel demonstrating results used in determining the limits of detection and PCR efficiency of amplifying the internal control and target sequence of E. intestinalis in accordance with an embodiment of FIG. 1.

FIG. 6 is an image of a gel demonstrating results used in determining the limits of detection and PCR efficiency of amplifying the internal control and target sequence of E. bieneusi in accordance with an embodiment of FIG. 1.

### DETAILED DESCRIPTION

In general, the various embodiments utilize molecular methods for detecting microsporidia such as, for example, E. bieneusi and/or E. intestinalis. Molecular methods for detecting microsporidia, such as PCR, have been shown to improve sensitivity 100-fold compared to microscopic analysis with special stains (Del Aguila, 1998). Embodiments of the invention provide for the development of molecular standards suitable for use in multiplexed E. bieneusi/E. intestinalis assay targeting the 18S ribosomal ribonucleic acid (rRNA) gene, an internal standard suitable for use in the multiplexed E. bieneusi/E. intestinalis assay targeting the 18S rRNA gene, PCR primers suitable for use in the multiplexed E. bieneusi/E. intestinalis assay targeting the 18S rRNA gene, species-specific probes suitable for hybridizing to the amplified products in the multiplexed E. bieneusi/E. intestinalis assay targeting the 18S rRNA gene, an assay method suitable for determining the presence of E. bieneusi and/or E. intestinalis, and an assay kit suitable for use in determining the presence of E. bieneusi and/or E. intestinalis.

### Methods

### Design Standards

It can be extremely difficult to obtain genomic (gDNA) control material for microbial pathogens. Microsporidia species are difficult to culture. Therefore, synthetic control material in the form of molecular standards is designed to be template material for development of assays. Molecular standards suitable for use in multiplexed E. bieneusi/E. intestinalis assay targeting the 18S rRNA gene are innovative research tools in their own right, allowing other academic and commercial researchers to validate their in-house research assays on common template material. The work flow pertaining to the design of these molecular standards is described in the non-provisional patent U.S. patent application Ser. No. 12/870,481, having a file date of Aug. 27, 2010, the disclosure of which is incorporated herein in its entirety.

### Design Workflow

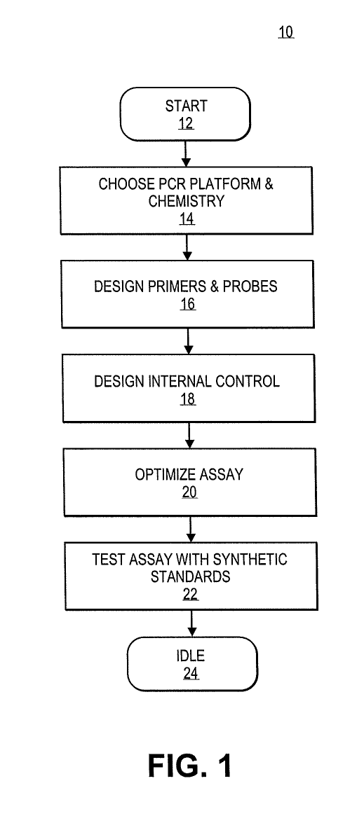

FIG. 1 is a flow diagram for a method 10 of designing polymerase chain reaction (PCR) assays according to an embodiment of the invention. As shown in FIG. 1, the method 10 is initiated at step 12. At step 14, the PCR platform and chemistry is chosen. The choice of real-time PCR chemistry is an important consideration for design, functionality, cost, and market reasons. Based upon extensive customer interviews with clinical laboratories it has been determined that the Roche LIGHTCYCLER® 1.5/2.0 is the most common platform found in clinical laboratories. The LIGHTCYCLER's® excitation lamp falls in the blue range, necessitating the use of FRET (Fluorescent Resonant Energy Transfer) to expand the number of applicable fluorophores, and thus the number of usable detection channels. Additionally, FRET probes afford the ability to perform melt curve analysis, which is crucial in differentiating the two microsporidial targets of focus. The use of hybridization FRET-based probes also provides a dual specificity for reactions, creating a detection assay that is more sensitive and more specific than with other PCR platforms/chemistry choices.

Due to the superior performance and availability in clinical laboratories of the LIGHTCYCLER® 2.0, it is preferred that the multiplex real-time PCR assay for E. bieneusi and E. intestinalis be performed on this platform with the use of FRET-based detection probes. This system allows melt curves to be generated for all channels, allowing for discrimination between the two targets of interest.

At step 16, the primers and probes to amplify, detect, and discriminate E. bieneusi and E. intestinalis are designed. Microsporidia primer/probe design is a critical step for successful real-time PCR detection. Oligonucleotide primers are by far the most important components of a PCR-based molecular assay and careful initial design can dramatically increase success rates. The 18S rRNA has been extensively characterized for E. bieneusi and E. intestinalis, and is the focus for primer/probe designs. A secondary target may include the Internal Transcribed Spacer locus. The estimated amplicon size for E. bieneusi is 143 bp (base pair) and E. intestinalis is 142 bp. The amplicons are differentiated through signal isolation of multiple fluorophore signals detected in different channels on the Roche LIGHTCYCLER® 2.0 platform. Examples of suitable primers to amplify, detect, and discriminate E. bieneusi and E. intestinalis are as follows:

Species- Specific 18s rRNA Primer Sequences:
E. intestinalis Forward primer:
SEQ ID NO: 1
5′-CCAAACAAAGACATACAAAA-3′
E. intestinalis Reverse primer:
SEQ ID NO: 2
5′-GAGTTTTTTTCGAGTGTAAA-3′
E. bieneusi Forward primer:
SEQ ID NO: 3
5′-TTAATTGCATTCACGACTAC-3′
E. bieneusi Reverse primer:
SEQ ID NO: 4
5′-GAGTATAAGACCTGAGTGTA-3′

The hybridization probes used allow for real-time detection of each microsporidial species, as well as allow discrimination between the two species of interest based on melt curve analysis. The LIGHTCYCLER® 2.0 has 6 optical channels in which hybridization probes can be detected. The LIGHTCYCLER® 2.0 is the instrument of choice due to its advanced optics and increased sensitivity.

Hybridization probe designs may be verified through software analysis. Examples of suitable hybridization software include with Visual OMP software manufactured by DNA Software, Inc. of Ann Arbor, Mich. 48104 U.S.A. The hybridization software may be utilized for in silico hybridization reactions, real-time PCR assays using previously validated primer sets, and gel electrophoresis. DNA for verification testing is the synthetic standards. Probe sets that produce sigmoidal amplification curves, distinct melt curves, and single-band gel electrophoresis are chosen for the final assay design. Examples of suitable hybridization probes to detect and discriminate E. bieneusi and E. intestinalis are as follows:

Species- Specific 18s rRNA Probe Sequences:
E. intestinalis Donor probe:
SEQ ID NO: 5
5′-GCAGCATTCACCATAGACACT-[36-FAM ™]-3′
E. intestinalis Acceptor probe:
SEQ ID NO: 6
5′-[5TEX ™615]-TGGAGCAGGTATTACCGC-[3SpC3]-3′
E. bieneusi Donor probe:
SEQ ID NO: 7
5′- AACTGCAGCATCCACCATAGAC-[36-FAM ™]-3′
E. bieneusi Acceptor probe:
SEQ ID NO: 8
5′-[5TYE ™705]-TCTTGGAGTTGGAGTTACCGC-[3SpC3]-3′

The probes include any suitable dye or other such label. Examples of suitable dyes include Freedom Dyes manufactured by Integrated DNA Technologies, Inc. of Coralville, Iowa 52241 U.S.A. The suitable dyes are covalently attached to either the 5′ or 3′ end of the sequence. Freedom Dyes are proprietary fluorophore solutions that are free from additional licensing requirements and are available for use in commercial diagnostic applications. Discrimination of E. bieneusi and E. intestinalis pDNA targets was based upon the detection of hybridization probes unique for each target, in separate channels on the LightCycler®2.0. E. bieneusi was detected in the 705 channel and E. intestinalis was detected in the 610 channel of the LightCycler®2.0.

Discrimination of probes in separate optical channels was established by labeling the donor probe of each target at the 3′ end with the fluorescein isomer derivative dye 6-carboxyfluorescein, commonly referred to as FAM™; the acceptor probe for E. bieneusi was conjugated at the 5′ end to the fluorescent dye TYE™705 and the acceptor for E. intestinalis was labeled with TEX™615.

At step 18, the internal control (IC) DNA and the probes detecting the internal control DNA are designed. The internal control is included in the design of the assay to detect failure of target DNA amplification. A common problem with clinical stool samples is the failure of the PCR reaction due to the presence of inhibitory substances. The internal control construct uses a pUC or similar plasmid as the base. An optimized, random DNA sequence is generated and then the reverse primer and the complimentary sequence of the forward primer of E. bieneusi is added flanking the random sequence. The amplicon size of the internal control is approximately 233 bp in total size; larger than either E. bieneusi or E. intestinalis amplicons to ensure that target DNA amplifies more efficiently, as well as allowing for gel electrophoresis discrimination during development of this product.

The internal control construct is synthesized, transfected, cloned, and isolated. To validate the success of the internal control construct, end-point PCR using E. bieneusi primers and gel electrophoresis was be performed.

A successful internal control construct design produces a single, strong amplicon that is distinguishable by size from E. bieneusi and E. intestinalis amplicons. Once the internal control construct is completed, hybridization probes are designed to detect its amplicon. The same principles are applied as for the design of E. bieneusi and E. intestinalis hybridization probes. The internal control hybridization probes are detected in a separate channel (670 nm wavelength) from the E. bieneusi and E. intestinalis hybridization probes.

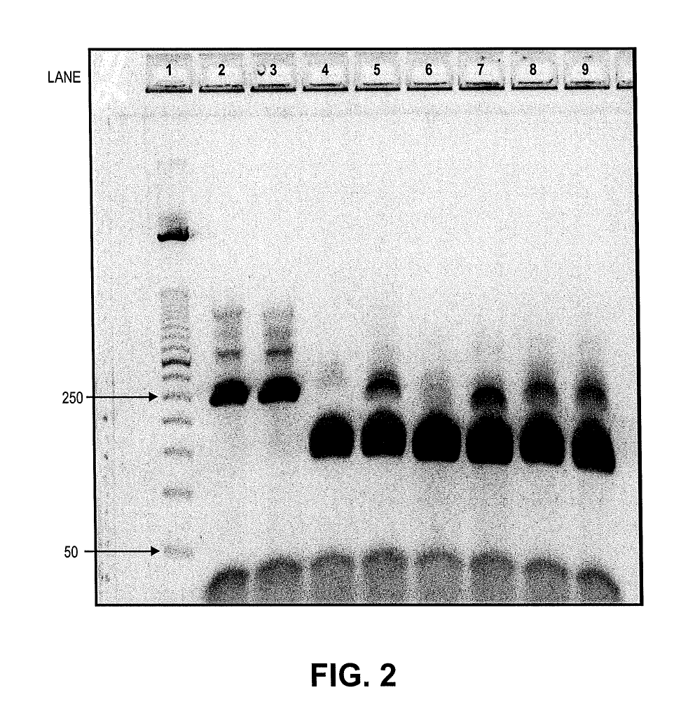

As shown in FIG. 2, gel analysis of the internal control DNA construct, lane 1 indicates a 50 bp (base pair) ladder. Lanes 2 and 3 show the internal control at 233 bp. Lanes 4 and 5 show the internal control amplified in the presence of 10⁵ E. bieneusi target DNA. Lanes 6 and 7 indicate the internal control DNA amplified in the presence of E. intestinalis DNA and lanes 8 and 9 indicate internal control DNA with both targets present.

The following is an example of a suitable Internal Control Sequence:

SEQ ID NO: 9
TTTTAACCTGTTGTAAAATTAGAGTATAAGACCTGAGTGTATTCTGACT
TTTGTCGTGCTGTGCGACACGTAAATTTAGTCCCCCAATAAATAACAG
GCCGCTGTTGAGCACAAGCAGCTAGCGCCGTTTTAGCCACATGTACCC
AGTATATATGTCACGAGAGGATAGGCGAACGGATGCTGACGAGGCAA
CAAAAGCACAGGTACTCGAGGGAAGGTTGGAATGGTCAGGCCGTAGT
CGTGAATGCAATTAAAACCTTGCTTAGATGTAATAT

Examples of suitable internal control probe sequences are as follows:

IC Donor probe:
SEQ ID NO: 10
5′-CGG ATG CTG ACG AGG CAA CA-[36-FAM ™]-3′
IC Acceptor probe:
SEQ ID NO: 11
5′-[5TYE ™665]-GCA CAG GTA CTC GAG GGA
AGG-[3SpC3]-3′

At step 20, the optimization of the assay is carried out by including different additives at varied concentrations. Synthetic target DNA is used in the optimization process due to the limited availability and high cost of genomic DNA. To briefly summarize, single-plex PCR is performed with two primers, amplification produces a single template, and confirmation is by real-time PCR cycle threshold (Ct) values and gel electrophoresis. Multiplex PCR is performed by adding more than one primer set and involves multiple templates that competitively co-amplify, therefore biased amplification can occur. Sensitivity may diminish in multiplex PCR as measured by an increase in cycle threshold values compared to those called in a single-plex assay. The following multiplex PCR variables are addressed sequentially to develop optimal conditions for E. bieneusi and E. intestinalis detection:

1) Primer/Probe concentration: Sensitivity of PCR amplification depends on the primer-to-template ratio. The primer-to-template ratio is important, as variation in the ratio can produce either decreased sensitivity or primer-dimerization. Lowering primer concentration can improve amplification by minimizing primer-dimers. As a result, primers are first added in equimolar amounts and then adjusted empirically (Bustin, 2004). Following primer optimization individual probe concentrations are examined to determine the optimal concentration for each donor and acceptor probe within the multiplex master mix.

2) MgCl₂/dNTP ratio: Because PCR enzymes are sensitive to these reagents, adjusting MgCl₂ concentration may improve multiplex PCR amplification. Additionally, dNTP stocks are sensitive to freeze-thaw cycles and should be aliquoted into small amounts, an effect less problematic with singleplex PCR.

3) Cycling conditions: Temperature and time adjustments within the various cycling conditions in real-time PCR maximize the DNA polymerized. Amplification can be increased by adjusting annealing temperatures +/−2 degrees. Typically, longer extension times will increase amplicon yield. Denaturation temperatures and times can be adjusted depending on the A/T content of the target DNA. Based upon these and/or other factors, the following Table 1 of cycling conditions may be generated:

TABLE 1
Cycling conditions for the multiplex PCR assay detecting
E. intestinalis and E. bieneusi.

| | | | |
|---|---|---|---|
| Step | Temperature (° C.) | Time | Acquisition Mode |

Denaturation (cycles: 1, analysis: None)

| | | | |
|---|---|---|---|
| Hot Start | 92-95 | 1 min | None |

Amplification (cycles: 50, analysis: Quantification)

| | | | |
|---|---|---|---|
| Denature | 92-95 | 10 sec | None |
| Anneal | 50-60 | 20 sec | Single |
| Extend | 70-72 | 30 sec | None |

Melting Curve (cycles: 1, analysis: Melting Curves)

| | | | |
|---|---|---|---|
| Denature | 95 | 0 sec | None |
| Anneal | 45 | 30 sec | None |
| Melting | 95 (slope = 0.1° C./sec) | 0 sec | Continuous |

Cooling (cycles: 1, analysis: None)

| | | | |
|---|---|---|---|
| Cooling | 40 | 30 sec | None |

4) PCR additives: DMSO, glycerol, betaine, and BSA can be considered empirically for multiplex reactions. Additives are used to reduce the formation of secondary structures that inhibit the polymerase and optimized based on the individual assay.

5) Buffer concentration: Higher salt concentration (2× buffer) has been reported to enhance multiplex amplification with short amplicons through more efficient denaturation (Markoulatos, 2002). KCl-based buffers may be advantageous because they require less dNTPs.

At step 22, the optimized assay is evaluated by the PCR performance of genomic DNA (E. bieneusi, E. intestinalis) and synthetic internal control. Monitoring and troubleshooting each component and step of a real-time PCR assay is necessary to ensure the best optimization. Through modification of each condition, testing by real-time PCR, and gel electrophoresis examination it was determined what conditions were optimal for this E. bieneusi and E. intestinalis multiplex assay.

The final formulation of R-SPHERE™ Microsporidia Detect is described in Table 2:

TABLE 2
Assay Optimization

| | Working | Final | μl/ |
|---|---|---|---|
| Component | Concentration | Concentration | reaction |
| HPLC-grade H₂O | | | 4.65 |
| PhthisisBuffer (X) | 10.00 | 1.00 | 2.00 |
| MgCl₂ (mM) | 200.00 | 3.50 | 0.35 |
| Trehalose (M) | 1.00 | 0.20 | 4.00 |
| dNTP (mM) | 10.00 | 0.80 | 1.60 |
| E. intestinalis Primer | 50.00 | 0.50 | 0.20 |
| Forward (uM) | | | |
| E. intestinalis Primer | 50.00 | 0.50 | 0.20 |
| Reverse (uM) | | | |
| E. bieneusi Primer | 50.00 | 1.00 | 0.40 |
| Forward (uM) | | | |
| E. bieneusi Primer | 50.00 | 1.00 | 0.40 |
| Reverse (uM) | | | |
| E. intestinalis Donor | 20.00 | 0.200 | 0.20 |
| Probe (uM) | | | |
| E. intestinalis Acc Probe | 20.00 | 0.400 | 0.40 |
| (uM) | | | |
| E. bieneusi Donor Probe | 20.00 | 0.200 | 0.20 |
| (uM) | | | |
| E. bieneusi Acc Probe | 20.00 | 0.400 | 0.40 |
| (uM) | | | |
| IC Donor Probe (uM) | 20.00 | 0.30 | 0.30 |
| IC Acc Probe (uM) | 20.00 | 0.30 | 0.30 |
| ICMS DNA (ng/uL) | 2.50E−07 | 1.25E−08 | 1.00 |
| HawkTaq Enzyme (U/uL) | 5.00 | 2.00 | 0.40 |
| Total Master Mix Volume | | | 17.00 |
| (uL) | | | |

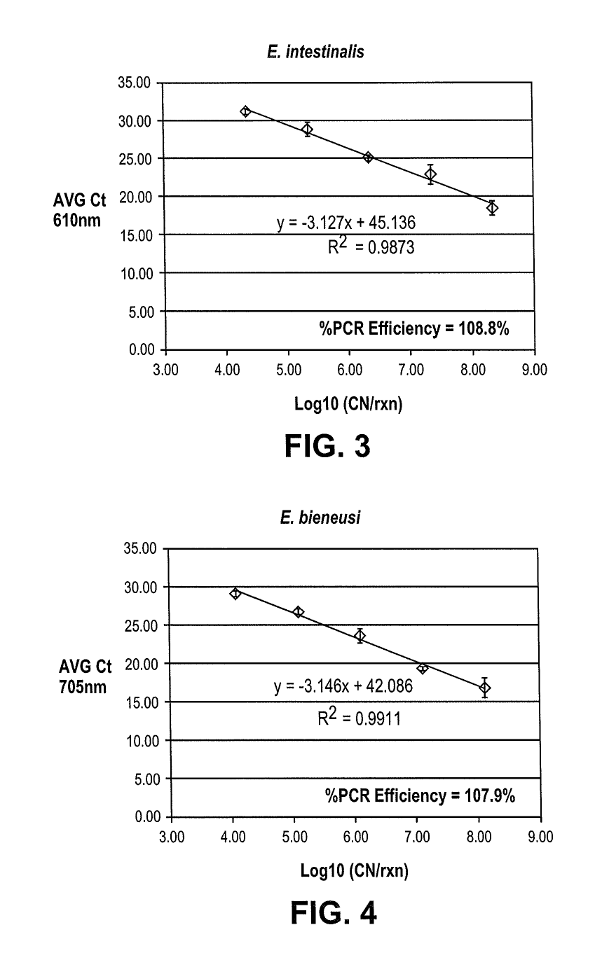

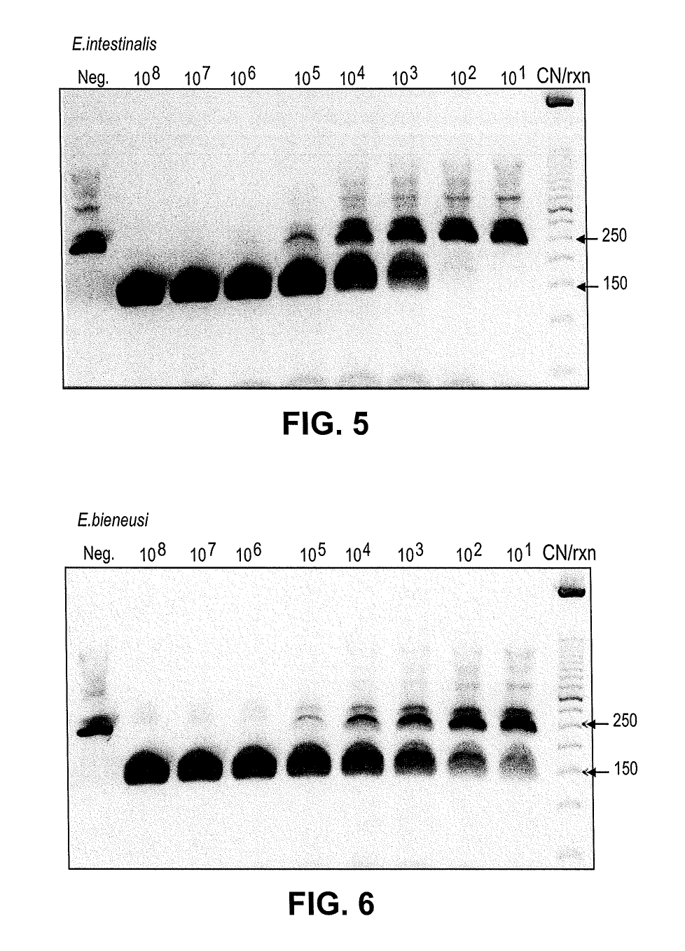

The performance of the optimized assay was assessed through PCR efficiency, sensitivity and reproducibility studies, the results of which are summarized in FIGS. 3 and 4 and Table 1.

In the following Table 3, the sensitivity and reproducibility of the assay data is summarized. The average Ct±Stdev with the Coefficient of Variance (% CV) for the analytical limit of detection (LOD) is expressed as CN per reaction (CN/r×n) for E. intestinalis and E. bieneusi pDNA. The average Tₘ±Stdev with % CV is included to confirm the accuracy of the PCR.

TABLE 3
Sensitivity and Reproducibility Data Summary.

| Sensitivity and Reproducibility | E. intestinalis | E. bieneusi |
|---|---|---|
| LOD (CN/rxn) | 10² | 10³ |
| Average Ct ± Stdev | 34.24 ± 0.91 | 32.94 ± 0.57 |
| % CV (Ct) | 2.65 | 1.70 |
| Average Tₘ (° C.) ± Stdev | 59.02 ± 0.38 | 59.45 ± 0.41 |
| % CV (Tₘ) | 0.65 | 0.69 |

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

### REFERENCES

Bustin, S. A. (2004). Primers and Probes. A-Z of Quantitative PCR (pp. 299-328). LaJolla: International University Line.
Del Aguila, C. G. (1998). Ultrastructure, immunofluorescence, Western blot, and PCR analysis of eight isolates of Encephalitozoon (Septata) intestinalis established in culture from sputum and urine samples and duodenal aspirates of five patients with AIDS. J. Clin. Microbiol., 1201-1208.
Garcia, L. S. (2002). Laboratory Identification of the Microsporidia. J. Clinical Microbiology, 1892-1901.
Markoulatos, P. N. (2002). Multiplex polymerase chain reaction: a practical approach. J. Clin. Lab. Anal, 47-51.
Molina, J. E. (2002). FUMAGILLIN TREATMENT OF INTESTINAL MICROSPORIDIOSIS. New England J Medicine, 1963-1969.
Reynolds, K. (2000). Microsporidia Outbreak Linked to Water. Water Conditioning & Purification, 1-2.
Xiao, L. S. (2004). Molecular epidemiology of human microsporidiosis caused by Enterocytozoon bieneusi. Southeast Asian journal of tropical medicine and public health, 40-47.

What is claimed is:

1. A multiplex PCR primer set comprising SEQ ID NO:1, SEQ ID NO:2, SEQ ID NO:3, and SEQ ID NO:4.

2. The multiplex PCR primer set according to claim 1, wherein the SEQ ID NO:1 and SEQ ID NO:2 are specific for Encephalitozoon intestinalis.

3. The multiplex PCR primer set according to claim 1, wherein the SEQ ID NO:3 and SEQ ID NO:4 are specific for Enterocytozoon bieneusi.

4. A kit for performing an assay to detect microsporidia, the kit comprising:
a multiplex PCR primer set comprising SEQ ID NO:1, SEQ ID NO:2, SEQ ID NO:3, and SEQ ID NO:4; and
a set of probes comprising SEQ ID NO:5, SEQ ID NO:6, SEQ ID NO:7, and SEQ ID NO:8.

5. The kit according to claim 4, wherein the SEQ ID NO:1 and SEQ ID NO:2 are specific for Encephalitozoon intestinalis.

6. The kit according to claim 4, wherein the SEQ ID NO:3 and SEQ ID NO:4 are specific for Enterocytozoon bieneusi.

7. The kit according to claim 4, further comprising a pair of primers specific for an internal control having the sequence of SEQ ID NO:9.

8. The kit according to claim 7, wherein the SEQ ID NO:3 and SEQ ID NO:4 are specific for the internal control having the sequence of SEQ ID NO:9.

9. The kit according to claim 7, further comprising a set of internal probes comprising SEQ ID NO:10 and SEQ ID NO:11.

10. The kit according to claim 4, further comprising a first dye being attached to the SEQ ID NO:6, wherein the first dye fluoresces at a wavelength of 605-620 nanometers (nm).

11. The kit according to claim 4, further comprising a second dye being attached to the SEQ ID NO:8, wherein the second dye fluoresces at a wavelength of 700-710 nm.

12. The kit according to claim 4, further comprising a third dye being attached to the SEQ ID NO:11, wherein the third dye fluoresces at a wavelength of 660-670 nm.

13. A method further comprising of a multiplex real-time PCR assay amplifying a target associated with diagnosis of microsporidia.

14. A method of identifying a microsporidia in a sample, the method comprising the steps of:
obtaining the sample;
performing a multiplex PCR assay on the sample and a multiplex PCR primer set comprising SEQ ID NO:1, SEQ ID NO:2, SEQ ID NO:3, and SEQ ID NO:4; and
determining the sample contains the microsporidia in response to the multiplex PCR assay amplifying a target sequence associated with microsporidia.

15. The method according to claim 14, wherein the SEQ ID NO:1 and SEQ ID NO:2 are specific for Encephalitozoon intestinalis.

16. The method according to claim 14, wherein the SEQ ID NO:3 and SEQ ID NO:4 are specific for Enterocytozoon bieneusi.

17. The method according to claim 14, further comprising an internal control having the sequence of SEQ ID NO:9 included in the multiplex PCR assay.

18. The method according to claim 17, wherein the SEQ ID NO:3 and SEQ ID NO:4 are specific for the internal control having the sequence of SEQ ID NO:9.

19. The method according to claim 17, further comprising a set of internal probes comprising SEQ ID NO:10 and SEQ ID NO:11 included in the multiplex PCR assay.

20. The method according to claim 14, further comprising a set of probes comprising SEQ ID NO:5, SEQ ID NO:6, SEQ ID NO:7, and SEQ ID NO:8 being included in the multiplex PCR assay.

21. The method according to claim 20, further comprising determining the patient is infected with Encephalitozoon intestinalis in response to detecting a first dye being attached to the SEQ ID NO:6, wherein the first dye fluoresces at a wavelength of 613 nanometers (nm).

22. The method according to claim 20, further comprising determining the patient is infected with Enterocytozoon bieneusi in response to detecting a second dye being attached to the SEQ ID NO:8, wherein the second dye fluoresces at a wavelength of 704 nm.

23. The method according to claim 19, further comprising determining the patient is infected with Enterocytozoon bieneusi in response to detecting a third dye being attached to the SEQ ID NO:11, wherein the third dye fluoresces at a wavelength of 665 nm.

24. The method according to claim 14, wherein the sample is obtained from a patient.

25. The method according to claim 14, wherein the sample is obtained from soil.

26. The method according to claim 14, wherein the sample is obtained from water.


SEQUENCE LISTING (11 sequences)

SEQ ID NO: 1 - DNA, 20 bp, Encephalitozoon intestinalis
ccaaacaaagacatacaaaa

SEQ ID NO: 2 - DNA, 20 bp, Encephalitozoon intestinalis
gagtttttttcgagtgtaaa

SEQ ID NO: 3 - DNA, 20 bp, Enterocytozoon bieneusi
ttaattgcattcacgactac

SEQ ID NO: 4 - DNA, 20 bp, Enterocytozoon bieneusi
gagtataagacctgagtgta

SEQ ID NO: 5 - DNA, 21 bp, Encephalitozoon intestinalis
gcagcattcaccatagacact

SEQ ID NO: 6 - DNA, 18 bp, Encephalitozoon intestinalis
tggagcaggtattaccgc

SEQ ID NO: 7 - DNA, 22 bp, Enterocytozoon bieneusi
aactgcagcatccaccatagac

SEQ ID NO: 8 - DNA, 21 bp, Enterocytozoon bieneusi
tcttggagttggagttaccgc

SEQ ID NO: 9 - DNA, 275 bp, Artificial Sequence
  Random sequence used for internal PCR control
ttttaacctgttgtaaaattagagtataagacctgagtgtattctgacttttgtcgtgctgtgcgacacgtaaatttagtcccccaataaataacaggccgctgttgagcacaagcagctagcgccgttttagccacatgtacccagtatatatgtcacgagaggataggcgaacggatgctgacgaggcaacaaaagcacaggtactcgagggaaggttggaatggtcaggccgtagtcgtgaatgcaattaaaaccttgcttagatgtaatat

SEQ ID NO: 10 - DNA, 20 bp, Artificial Sequence
  Primer for random sequence used for internal PCR control
cggatgctgacgaggcaaca

SEQ ID NO: 11 - DNA, 21 bp, Artificial Sequence
  Primer for random sequence used for internal PCR control
gcacaggtactcgagggaagg